(19) United States
(12) Patent Application Publication
(10) Pub. No.: US 2016/0100465 A1
(43) Pub. Date: Apr. 7, 2016

(54) SYSTEM AND METHOD FOR SOFTWARE AND PERIPHERAL INTEGRATION

(71) Applicant: Logitech Europe S.A., Lausanne (CH)

(72) Inventors: William Prescott, Fremont, CA (US); Mark Starrett, Fremont, CA (US)

(21) Appl. No.: 14/508,996

(22) Filed: Oct. 7, 2014

(51) Int. Cl. H05B 33/08; H04M 1/22; G06F 3/02; G06F 3/023

(52) U.S. Cl. CPC H05B 33/0845; G06F 3/0238; H04M 1/22; G06F 3/0202; G06F 3/0219

(57) ABSTRACT

A computer implemented method comprising receiving input from an input device having a plurality of keys, the input corresponding to individual key presses of the plurality of keys. The method further includes tracking the individual key presses over a period of time, determining time-based analytics for each of the individual keys, providing a graphical representation of the plurality of keys, and modifying the graphical representation of each of the plurality of keys based on the time-based analytics. The time-based analytics can include a key press frequency or a key press duration of each key over the period of time. The graphical representation can be a heat map on a display. Alternatively, the heat map can be represented on hardware including LEDs for each individual key on the input device. The method further includes storing the individual key presses over the period of time as a session.

### BACKGROUND

Keyboards are ubiquitous in contemporary electronics in the last several decades and have been used for text entry in general for well over a century. Although many mechanical improvements have been made to improve ergonomics, responsiveness, and reliability, little has changed in terms of function. That is, contemporary keyboards are still primarily designed as passive input devices used for alphanumeric text entry.

The PC gaming industry has pushed the development and evolution of keyboard designs. Gamers demand fast communications from peripherals, fast and reliable keys, or any other feature that can provide a competitive edge. However, the physical differences in gamer's playing styles, key assignments, or other configurations, prevents any one default setting from accommodating all user preferences from one player to the next. Furthermore, differences in key assignments from application-to-application may force gamers to have to relearn new key layouts or playing styles by a cumbersome trial-and-error process. Even well-known and widely used key assignments may be efficient for some users and inefficient for others due to slight differences or peculiarities from one gamer to the next.

Thus, there is a need for keyboard designs that can provide more significant performance enhancements for a wide variety of users.

### BRIEF SUMMARY

In certain embodiments, a method comprises receiving input from an input device having a plurality of keys, the input corresponding to individual key presses of the plurality of keys. The method further includes tracking the individual key presses over a period of time, determining time-based analytics for each of the individual keys, providing a graphical representation of the plurality of keys, and modifying the graphical representation of each of the plurality of keys based on the time-based analytics. The time-based analytics can include a key-press frequency or a key-press duration of each key over the period of time.

The graphical representation can be a heat map on a display. The heat map can also be represented on hardware. For example, a peripheral (e.g., keyboard) having LEDs on each individual key can represent various forms of heat maps based on color, intensity, or other suitable characteristic. The method further includes storing the individual key presses over the period of time as a session. Sessions can be distinguished by per-game, per-application, per-period, or other suitable metric to track performance under a particular condition, duration, etc.

In some embodiments, the method further includes determining a weighted average of the keys with the highest key press frequency, and generating a graphical representation of the weighted average. The graphical representation can be depicted on any suitable display or suitable hardware (e.g., LEDs on a keyboard).

In some implementations, the method further includes analyzing the time-based analytics for each of the individual keys over the period of time, identifying ergonomic inefficiencies based on the time-based analytics, and determining an ergonomically-improved key mapping configuration based on the time-based analytics.

In certain embodiments, a computer-implemented system comprises one or more processors and one or more non-transitory computer-readable storage mediums containing instructions configured to cause the one or more processors to perform operations including generating control data to control a peripheral device. The control data can include key routing data to individually address one or more keys on the peripheral device, and key function data to control one or more functions associated with the one or more keys of the peripheral device. The instructions further cause the one or more processors to perform operations including controlling the individually addressed one or more keys on the peripheral device based on the key function data. A light can be disposed within or adjacent to each of the one or more keys, and the key function data can control one or more of a color, brightness, and lighting pattern for the light of the one or more keys. The light may be one or more light emitting diodes (LEDs).

In some embodiments, the one or more non-transitory computer-readable storage mediums further contain instructions configured to cause the one or more processors to perform operations including receiving input data from the peripheral device corresponding to key presses of the one or more keys, and determining time-based analytics for each of the individual keys, wherein the time-based analytics includes a key press frequency over a period of time. The key function data causes the light for each of the one or more keys to have a particular color, brightness, or lighting pattern based on the time-based analytics for that particular key.

In further embodiments, an input device includes a plurality of keys, a plurality of LEDs, and a processor. Each LED is associated with one of the plurality of keys. The processor can individually address each LED and individually control a function of each LED including a color, brightness, or lighting pattern. The processor can determines time-based analytics for each of the plurality of keys. Time-based analytics can include a key press frequency over a period of time and/or a key press duration. In some embodiments, the processor can control the function of each LED based on the time-based analytics for that particular key.

In certain embodiments, the processor is operable to receive control from a host computing device, the control data including key routing data to individually address one or more of the plurality of LEDs on the peripheral device, and key function data to control one or more functions associated with the one or more keys of the peripheral device. The processor can further control the function of each LED based on the key function data from the host computing device. In some cases, the processor can determine a key mapping configuration based on the time-based analytics.

In further embodiments, a keyboard (or more generally, an input device) includes a plurality of keys, a plurality of LEDs, where each LED is associated with one of the plurality of keys, and a processor configured to individually address each LED and individually control a function of each LED including a color, brightness, or lighting pattern. The processor can be disposed in the keyboard, or it can be disposed in and controlled by a host device separate from the keyboard. The processor can be configured to individually address each key along with, or independent of each LED.

In some implementations, the processor is configured to receive and process control data from a host device. The control data can include key routing data to individually address one or more of the plurality of keys on the keyboard, and key function data to control one or more functions associated with the one or more keys of the plurality of keys on the keyboard.

### BRIEF DESCRIPTION OF THE DRAWINGS

FIG. 1 illustrates an example of a heat map for a plurality of keys over a period of time, according to certain embodiments of the invention.

FIG. 2 illustrates a use count heat map, according to certain embodiments of the invention.

FIG. 3 illustrates a duration heat map, according to certain embodiments of the invention.

FIG. 4 illustrates aspects of time-based analytics in the form of a “DNA” band chart, according to certain embodiments of the invention.

FIG. 5 illustrates is a frequency histogram showing key press frequency and duration, according to certain embodiments of the invention.

FIG. 6 is a simplified flow diagram illustrating a method of generating a use heat map for an input device, according to certain embodiments of the invention.

FIG. 7 is a simplified flow diagram illustrating a method of generating a use heat map and displaying the use heat map on the keys of a physical input device, according to certain embodiments of the invention.

FIG. 8 illustrates a user interface (UI) depicting a virtual keyboard, according to certain embodiments of the invention.

FIG. 9 illustrates user interface in the key mapping mode, according to certain embodiments of the invention.

FIG. 10 illustrates user interface in the key mapping mode, according to certain embodiments of the invention.

FIG. 11 illustrates an example of a peripheral control software (UI) configured to control lighting parameters for a plurality of keys on a keyboard, according to certain embodiments of the invention.

FIG. 12 illustrates an example of peripheral control software (UI) configured to control lighting parameters on a plurality of physical keys, according to certain embodiments of the invention.

FIG. 13 illustrates an example of peripheral control software (UI) configured to control lighting parameters on a plurality of physical keys, according to certain embodiments of the invention.

FIG. 14 illustrates an example of peripheral control software (UI) configured to control lighting parameters on a plurality of physical keys, according to certain embodiments of the invention.

FIG. 15 illustrates an example of a user interface to control aspects of the operation of a supplementary display, according to certain embodiments of the invention.

FIG. 16 illustrates an example of a UI for controlling key mapping aspects of the operation of a supplementary display, according to certain embodiments of the invention. More

FIG. 17 illustrates an example of a UI for controlling media aspects from a supplementary display, according to certain embodiments of the invention.

FIG. 18 illustrates an example of a UI for controlling aspects of the operation of an input device from a supplementary display, according to certain embodiments of the invention.

FIG. 19 illustrates an example of a UI for displaying performance characteristics of a system from a supplementary display, according to certain embodiments of the invention.

FIG. 20 illustrates an example of a UI for displaying performance characteristics of a system from a supplementary display, according to certain embodiments of the invention.

FIG. 21 illustrates usable keys in green and unusable keys (not active yet) in orange, according to certain embodiments of the invention

FIG. 22 is a simplified block diagram illustrating a system for operating a secondary interactive display and controlling aspects of each individual key in a physical keyboard, according to certain embodiments of the invention.

FIG. 23 is a simplified schematic diagram of a computer system, according to certain embodiments of the present invention.

FIG. 24 illustrates a simplified representation of a computer system for generating a use heat map for a peripheral device, according to certain embodiments of the invention.

### DETAILED DESCRIPTION

Certain embodiments of the present invention are related to aspects of software and peripheral control, key layout heat mapping, keyboard time-based analytics, and session analysis.

In certain embodiments, a method comprises receiving input from an input device having a plurality of keys, the input corresponding to individual key presses of the plurality of keys. The method further includes tracking the individual key presses over a period of time, determining time-based analytics for each of the individual keys, providing a graphical representation of the plurality of keys, and modifying the graphical representation of each of the plurality of keys based on the time-based analytics. The time-based analytics can include a key-press frequency or a key-press duration of each key over the period of time.

The graphical representation can be a heat map on a display. The heat map can also be represented on hardware. For example, a peripheral device (e.g., keyboard) having LEDs on each individual key can represent various forms of heat maps based on color, intensity, or other suitable characteristic. The method further includes storing the individual key presses over the period of time as a session. Sessions (as well as periods of time) can be distinguished by per-game, per-application, per-period, or other suitable metric to track performance under a particular condition, duration, etc.

Heat Mapping

Heat maps can be used to present a graphical representation of how often or how long a certain activity occurred. With respect to the present invention, some embodiments utilize heat maps to graphically represent how one or more keys in an array of keys are pressed (e.g., actuated) over a period of time. Heat maps can show a key press frequency (i.e., how often each key is pressed), key press duration (i.e., how long each key was pressed), when a key was pressed, when a first key was pressed with respect to a second key, or other suitable metric, for each key in the array of keys. The array of keys can be a keyboard, key pad, or any suitable arrangement of keys in one or more devices.

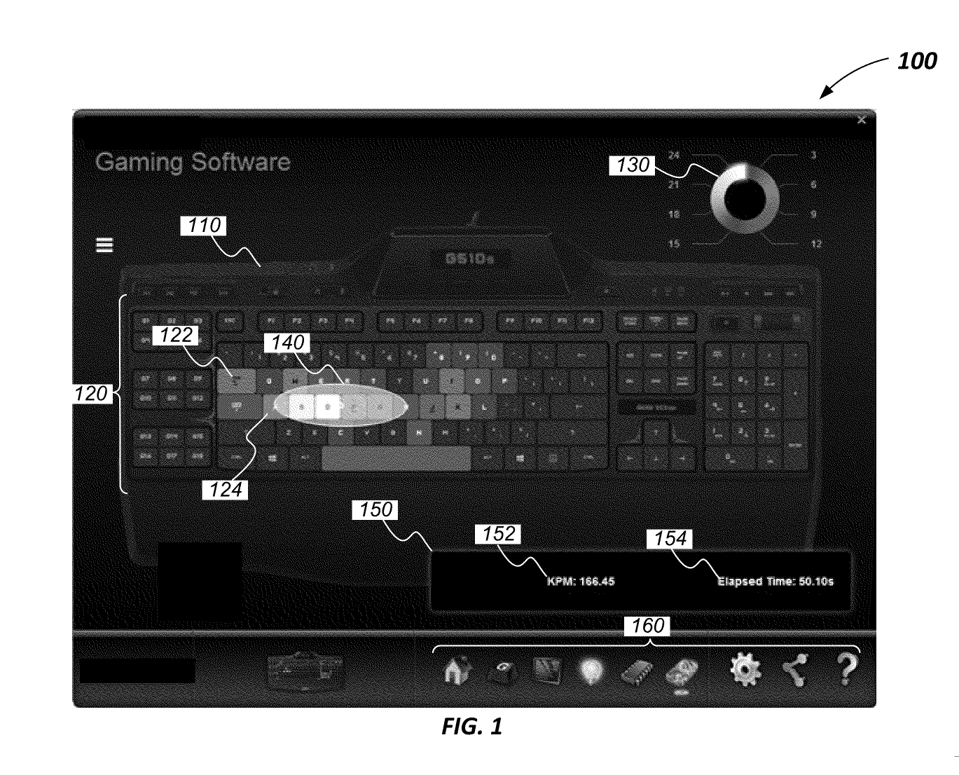

FIG. 1 illustrates a graphical depiction of a heat map 100 for a plurality of keys over a period of time, according to certain embodiments of the invention. The heat map depiction includes a keyboard 110, a heat map legend 130, a performance data block 150, and a utility block 160. Keyboard 110 includes a plurality of keys 120. Heat map legend 130 includes a color wheel indicating which color corresponds to a specific number of key presses. In some cases, a monochromatic or grayscale representation can be used. Certain embodiments may include more blocks, regions, functions, and the like. Some embodiments may use less blocks, different graphical representations, configurations, or the like, as would be appreciated by one of ordinary skill in the art.

Referring to FIG. 1, a standard heat map view shows the frequency that each key was pressed relative to other keys. In this view, it can be seen which keys were pressed the most. Also, the white ellipse 140 indicates which area received the most key presses. In some cases, ellipse 140 is a “weighted average” of the location of all key presses over a period of time. The sensitivity of ellipse 140 can be configured to preferred settings, as would be appreciated by one of ordinary skill in the art. In this example, key 122 was pressed approximately 8 times, while key 124 was pressed approximately 17 times. Ellipse 140 can also be used to determine the area of the keyboard most utilized, which can be useful when evaluating whether more efficient key layouts are possible, as further discussed below.

Performance data block 150 shows the keys pressed per minute and the elapsed time. In FIG. 1, the user is typing 166.46 keys per minute (KPM) over an elapsed time of 50.1 seconds). Utility block 160 depicts a number of utilities (e.g., home, key layout control, display configuration control, heat map presentation controls, and more). Heat map 100 can be updated passively (e.g., after a period of use) or dynamically in real time.

Sessions

Heat maps can be saved as “sessions.” This allows a user to view which buttons were pressed for a specific time period (e.g., daily, monthly use), a particular application (e.g., video game), or the like.

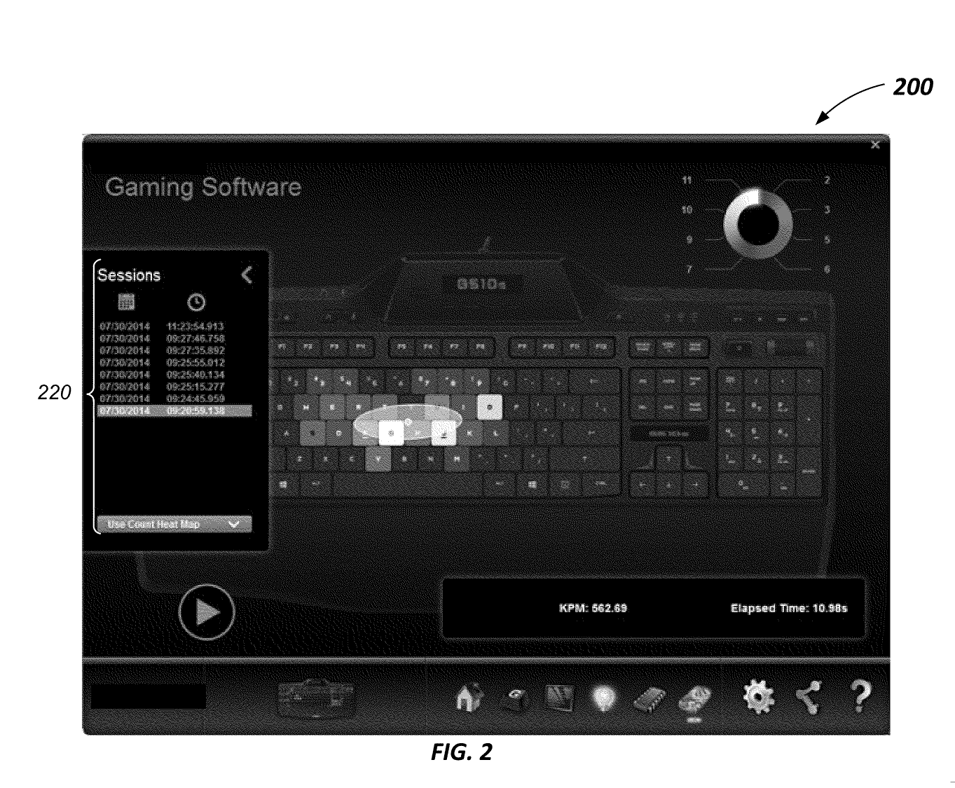

FIG. 2 illustrates a use count heat map 200, according to certain embodiments of the invention. A use count refers to how many times the keys are pressed over a given period of time. In this non-limiting example, heat map 200 includes a “sessions” section 220 that depicts a number of saved sessions organized by date and/or time. Sessions can be organized by application (game), by day, by software runtime use, or other method of organizing a period of time or purpose of use. In another example, a heat map may be stored for a particular game by the date played, per game round (in-game period of time), per game execution (each time the game is loaded), or other suitable denomination of time. In some implementations, sessions can be configured to record in a cumulative manner when a particular game is played over a number of times.

In some embodiments, sessions may be manually set by a user. Alternatively, sessions can be automated (automatically start/stopped) and programmable by a user. In some cases, certain applications may control the heat map software and provide session presets (e.g., start/end times, heat map configurations), thus providing automatic (and configurable) settings

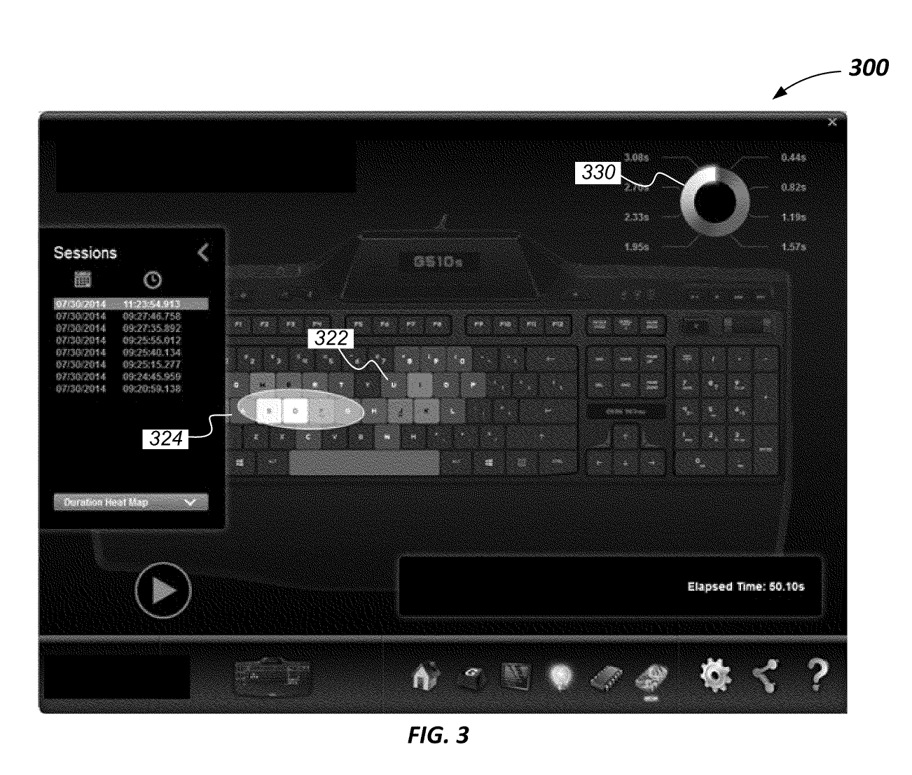

FIG. 3 illustrates a duration heat map 300, according to certain embodiments of the invention. The heat map 300 shows which keys were pressed for a given session (e.g., 7/30/2014 at 11:23:54 AM) and how long they were pressed. Using the heat map legend 330, the ‘U’ key 322 was pressed approximately 0.44 seconds, and the ‘A’ key 324 was pressed for approximately 2.1 seconds. Heat map 300 is otherwise similar to the heat map of FIGS. 1-2. One purpose of the duration heat map is to show which keys have been pressed down the longest over a period of time (e.g., session).

Time-Based Analytics

Time-based analytics can relate certain performance metrics that can be gleaned from receiving input from an input device having a plurality of keys (e.g., keyboard), where the input corresponds to individual key presses of the plurality of keys, and tracking the individual key presses over a period of time. Time-based analytics can be determined for each of the individual keys and may include a key-press frequency, a key-press duration, key press time and/or duration relative to one another, metrics that study multiple key press combinations, key press sequences, and the like.

Time-based analytics can be the study of these metrics over a particular session, a group of sessions, or any suitable period of time.

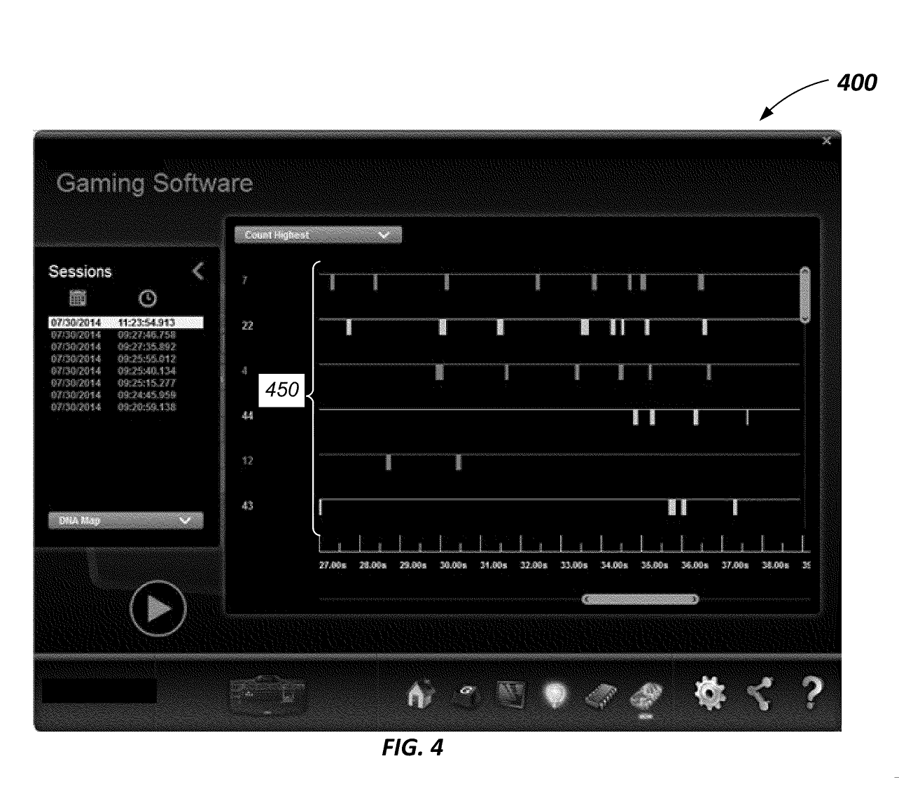

FIG. 4 illustrates aspects of time-based analytics in the form of a “DNA” band chart 450, according to certain embodiments of the invention. This view provides the key press in the time domain. It is similar to a musical display (e.g., MIDI piano roll) that allows the user to visualize key “chording.” For instance, other heat map presentations may indicate how often you pressed a key or for how long you pressed a key, but they may not depict how keys are pressed in relation to one another, whether they are overlapping (pressed at the same time), or the like.

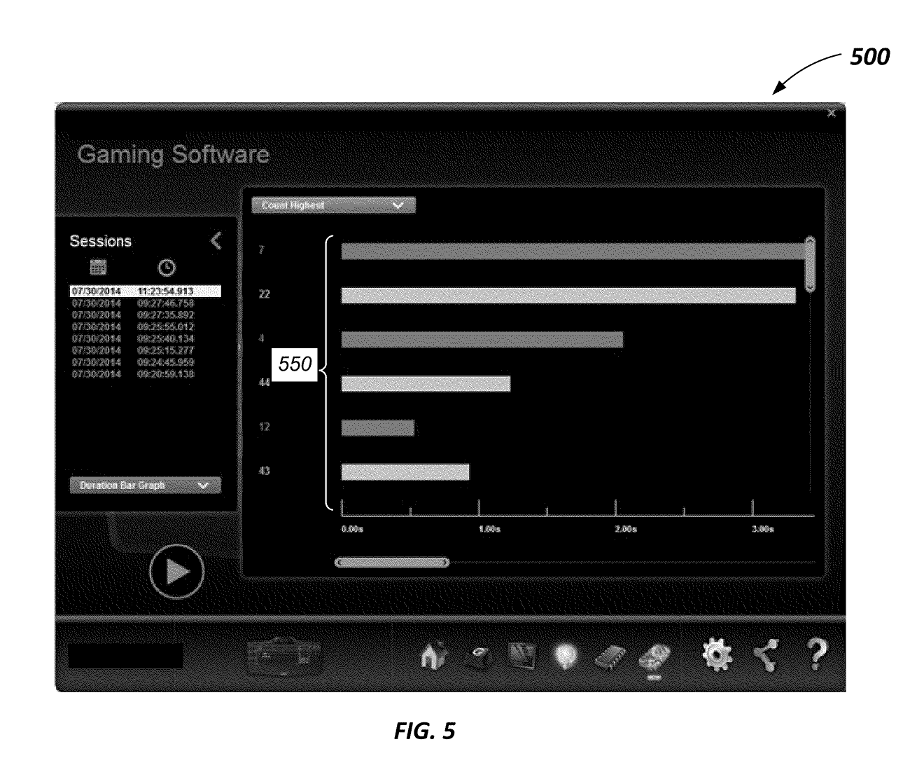

The “DNA” band chart can show which keys are pressed at the same time. Furthermore, sequences of key presses can be identified an analyzed. This can be useful when analyzing whether a particular key layout is efficient for a given application. For instance, a gamer may use a particular multi-key command that occurs simultaneously or in quick succession that may be difficult or awkward to execute quickly, consistently, or accurately. Thus, the heat mapping software can perform time-based analytics based on the DNA map to determine, for example, better key layout configurations for a particular user to improve typing speed, consistency, and accuracy. Other chart representation showing various time-based analytics can be used, as would be appreciated by one of ordinary skill in the art. For example, FIG. 5 illustrates is a frequency histogram 550 showing key press frequency and duration, according to certain embodiments of the invention.

Virtual Coaching

Using time-based analytics, heat mapping software can analyze characteristics of a keyboard user's key press habits over a period of time (e.g., session(s)). The software can then determine inefficiencies in the key layout, teach or suggest new key mappings, and present practice patterns to train a user to try different key layouts, key press patterns, or the like. Key mapping can be referred to as key binding.

For example, a user may have a particular key layout when playing first person shooter (FPS) styled games. By using time-based analytics, embodiments of the invention can determine better key arrangements to improve a user's key press execution time, especially with particular key sequences or key combinations. In some cases, the software can also suggest key layouts based on usage patterns and offer ergonomically-tuned alternative experiences.

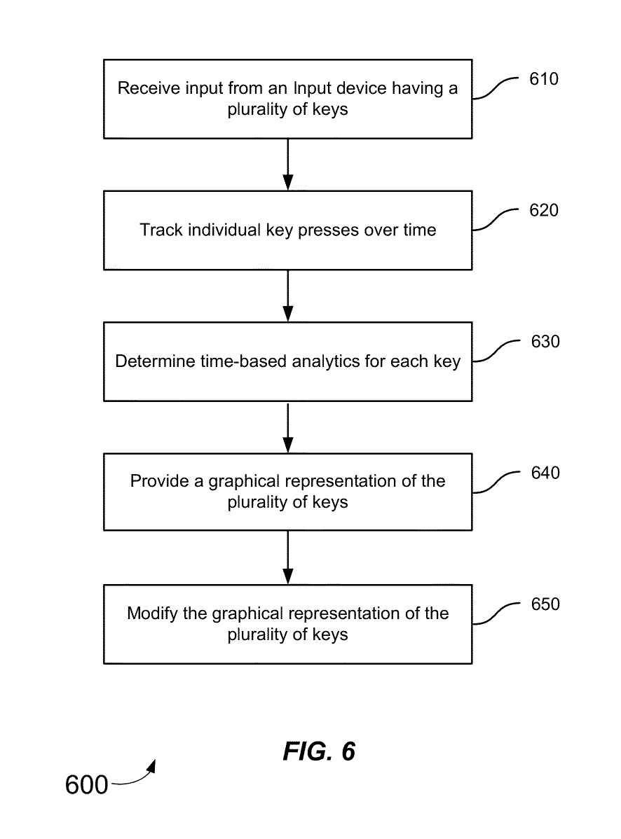

FIG. 6 is a simplified flow diagram illustrating a method 600 of generating a use heat map for an input device, according to certain embodiments of the invention. Method 600 can be performed by processing logic that may comprise hardware (circuitry, dedicated logic, etc.), software (such as is run on a general purpose computing system or a dedicated machine), firmware (embedded software), or any combination thereof. In one embodiment, method 600 can be performed by processor 2240 and implemented on system 2200.

Referring to FIG. 6, step 610 includes receiving an input from an input device having a plurality of keys. For example, the input can correspond to individual key presses on the input device. An input device can include any suitable computer peripheral device with a plurality of keys including a keyboard, keypad, mouse, game pad, or other suitable input device.

At step 620, the method 600 includes tracking individual key presses over a period of time. The period of time can be any range of time (e.g., seconds, minutes, hours, etc.). The period of time can be a session, which may include periods of time while using a particular, as further described above. In some embodiments, the method 600 includes storing the individual key presses over the period of time as a session, where the session is one of a per-game session, per-application session, or per-period session.

At step 630, the method 600 includes determining time-based analytics for each of the individual keys, wherein the time-based analytics includes a key press frequency over the period of time. The key press frequency includes how often a key was pressed during the period of time. Other time-based analytics can be used, such as key press duration, key press timing (e.g., with respect to other keys), and the like.

At step 640, the method 600 includes providing a graphical representation of the plurality of keys. The graphical representation can be provided on a display in any suitable format. In some embodiments, the graphical representation is in the form of a use or duration heat map. At step 650, the method 600 includes modifying the graphical representation of each of the plurality of keys based on the time-based analytics.

In further embodiments, the method 600 can include determining a weighted average of the keys with the highest key press frequency, and generating a graphical representation of the weighted average. The method 600 can further include analyzing the time-based analytics for each of the individual keys over the period of time, identifying ergonomic inefficiencies based on the time-based analytics, and determining an ergonomically-improved key mapping configuration based on the time-based analytics.

It should be appreciated that the specific steps illustrated in FIG. 6 provide a particular method 600 of generating a use heat map for an input device, according to certain embodiments of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 600.

Hardware and Peripheral Integration

In addition to displaying heat maps, analytics, key mapping recommendations, coaching algorithms, etc., on a display (e.g., monitor), any of the functions, features, and concepts described herein can be output to a physical peripheral device, such as a keyboard, key pad, mouse, game pad, or other suitable input device with a plurality of keys. Certain embodiments of the invention include software that can individually address any of the keys on an input device (e.g., keyboard, mouse, etc.) and control certain aspects of the particular key. Some controllable features of each key include lighting (e.g., heat maps on keys), haptic feedback (e.g., vibrations), key press resistance profiles, or any other aspect, as would be appreciated by one of ordinary skill in the art with the benefit of this disclosure. By enabling a user to physically put his hands on the input device (e.g., keyboard) to see, e.g., heat maps, and feel, e.g., new key mapping arrangements, can significantly enhance and improve a user's interactive experience. Some of these enhancements are described in the following non-limiting examples.

The technical aspects of individually programming key press resistance profiles are not discussed in great detail so as to prevent the obfuscation of the inventive concepts described herein. A more detailed description of the programmable resistance profiles can be found in U.S. Pat. No. 8,482,517, filed Jan. 12, 2009, and entitled “Programmable Analog Keys for a Control Device,” which is hereby incorporated by reference in its entirety for all purposes.

For instance, keys can be tied to a function that can include in-game information. That is, in-game real-time data can be represented and displayed on the LEDs by individually addressing the appropriate LEDs on an input device and providing function data to control a lighting aspect of the LED that corresponds to the in-game real-time data. Some of the applications of individual key lighting and game integration include the following scenarios: showing in-game directional damage by flashing a group of LEDs a particular on a corresponding side of the keyboard (e.g., player hit on the left causes LEDs to flash red on left most keys on keyboard), using “cool down” lighting to indicate when periodically available functions are available (e.g., a key changes color from red to green when a function assigned to that particular key becomes available), and causing LED colors can fade in or out to indicate game related functions, and the like. In another example, certain keys may light up to indicate to a user that a particular function is available. In further embodiments, only certain LEDs may light up to indicate to a user that only the commands associated with the lighted keys are available for execution at that particular time or in that particular mode of operation or setting.

In some embodiments, the heat maps depicted on the virtual keyboards of FIGS. 1-3 can be presented on the individual keys of a physical keyboard. For example, the LEDs in a keyboard can emit different colors that correspond to how often the particular key was pressed during a session.

Individual Key Lighting and Control

In some embodiments, a computer-implemented system can include one or more processors, and one or more non-transitory computer-readable storage mediums containing instructions configured to cause the one or more processors to perform operations including generating control data to control a peripheral device (e.g., input device, keyboard, etc.). The control data can include key routing data to individually address one or more keys on the peripheral device, and key function data to control one or more functions associated with the keys of the peripheral device. The system can control the individually addressed one or more keys on the peripheral device based on the key function data. In certain implementations, a light is disposed within or is adjacent to each of the one or more keys, and the key function data can control one or more of a color, brightness, and lighting pattern for the light of the one or more keys. The light can be a light emitting diode (LED) or some variant thereof, as would be appreciated by one of ordinary skill in the art. In an exemplary embodiment, a keyboard includes a number of keys where an LED is disposed within or adjacent to each of the number of keys. Each key and/or each LED corresponding to each key can be individually addressable such that software can control aspects only pertaining to that particular key. As such, a program operated by a host computer can cause a single key to light up a particular color in any desired fashion.

The technical aspects of physically integrating LED's with individual keys are not discussed in great detail so as to prevent the obfuscation of the inventive concepts described herein. A more detailed description of the physical integration of LED's with input keys can be found in U.S. Provisional Patent Application No. 62/051,551, filed Sep. 17, 2014, and entitled “Keyboard Illuminated Switch,” which is hereby incorporated by reference in its entirety for all purposes.

Heat Maps Displayed on a Peripheral Device

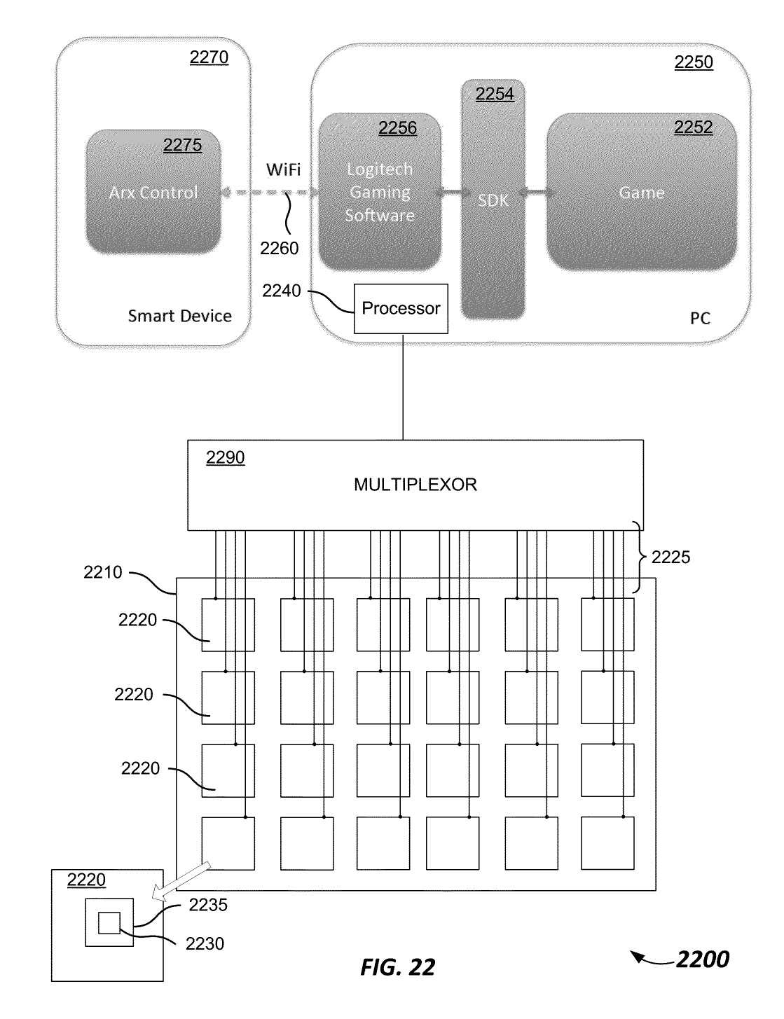

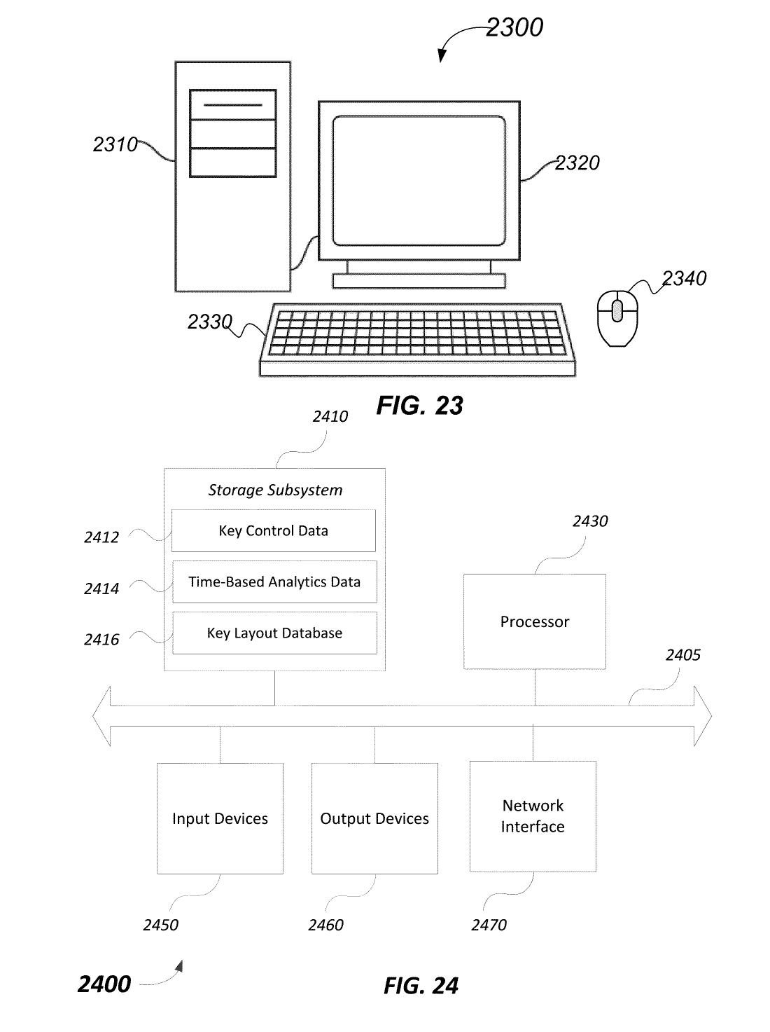

FIGS. 1-3, discussed above, illustrate aspects of generating heat maps on a virtual keyboard that correspond to actual key presses on a physical input device (e.g., physical keyboard) over a period of time (e.g., session). Heat maps can also be displayed on the physical input device as well. For instance, the heat map of FIG. 1 can be mapped on to the actual, physical individual keys of a keyboard (e.g., keyboard 2210 of FIG. 22 or keyboard 2330 of FIG. 23. That is, the physical ‘A’ key 124 can be illuminated orange (i.e., via LED), the physical ‘R’ key 140 can be illuminated blue green, and the tab key 122 can be illuminated blue on the physical keyboard, as shown in the virtual keyboard of FIG. 1.

Thus, a real-time heat map can be implemented on the LEDs of one or more keys of an input device. For example, heat maps can include a cumulative representation of the number of key presses during a current session. Alternatively, the heat map can be a representation of the total key press duration for the current session. During longer sessions, many of the most commonly pressed keys may reach a maximum value and exhibit the same color. For example, heat map legend 130 indicates that key presses at or above 24 are white. It can be appreciated that the movement keys (e.g., “WASD”) or trigger key in a first-person shooter (FPS) game would be white after a very short amount of time. Thus, for aesthetic effect, certain heat map colors can “age out” over time, such that an LED associated with a frequently pressed key may slowly change color through the heat map spectrum (e.g., white to yellow to red to blue, etc.) as time progresses and eventually fade to black (no light) if the key is not pressed again during the current session.

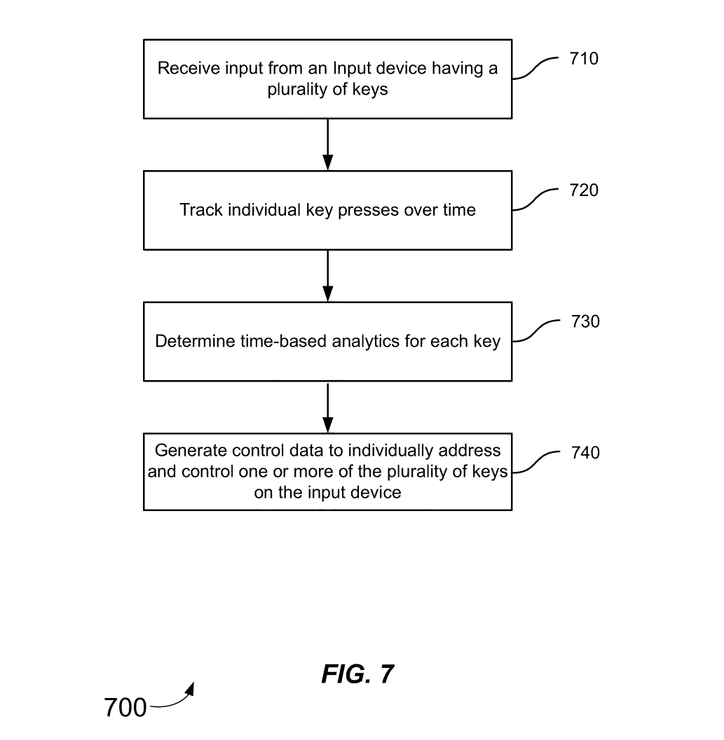

FIG. 7 is a simplified flow diagram illustrating a method 700 of generating a use heat map and displaying the use heat map on the keys of a physical input device, according to certain embodiments of the invention. The method 700 can be performed by processing logic that may comprise hardware (circuitry, dedicated logic, etc.), software (such as is run on a general purpose computing system or a dedicated machine), firmware (embedded software), or any combination thereof. In some embodiments, method 700 can be performed by processor 2240 and implemented on system 2200.

Referring to FIG. 7, at step 710, the method 700 includes receiving an input from an input device having a plurality of keys. For example, the input can correspond to individual key presses on the input device. An input device can include any suitable computer peripheral device with a plurality of keys including a keyboard, keypad, mouse, game pad, or other suitable input device.

At step 720, the method 700 includes tracking individual key presses over a period of time. The period of time can be any range of time (e.g., seconds, minutes, hours, etc.). The period of time can be a session, which may include periods of time while using a particular, as further described above. In some embodiments, the method 700 includes storing the individual key presses over the period of time as a session, where the session is one of a per-game session, per-application session, or per-period session.

At step 730, the method 700 includes determining time-based analytics for each of the individual keys, wherein the time-based analytics includes a key press frequency over the period of time. The key press frequency includes how often a key was pressed during the period of time. Other time-based analytics can be used, such as key press duration, key press timing (e.g., with respect to other keys), and the like.

At step 740, the method 700 includes generating control data to individually address and control one or more of the plurality of keys on the input device. In some embodiments, the control data causes the one or more of the plurality of keys to light up (via LED) according to a heat map based on the time-based analytics. In some embodiments, control data that can control other functions associated with the plurality of keys can be generated. For instance, control data may control one or more of the lighting/color aspects of an LED, or a haptic feedback for the one or more keys of the plurality of keys.

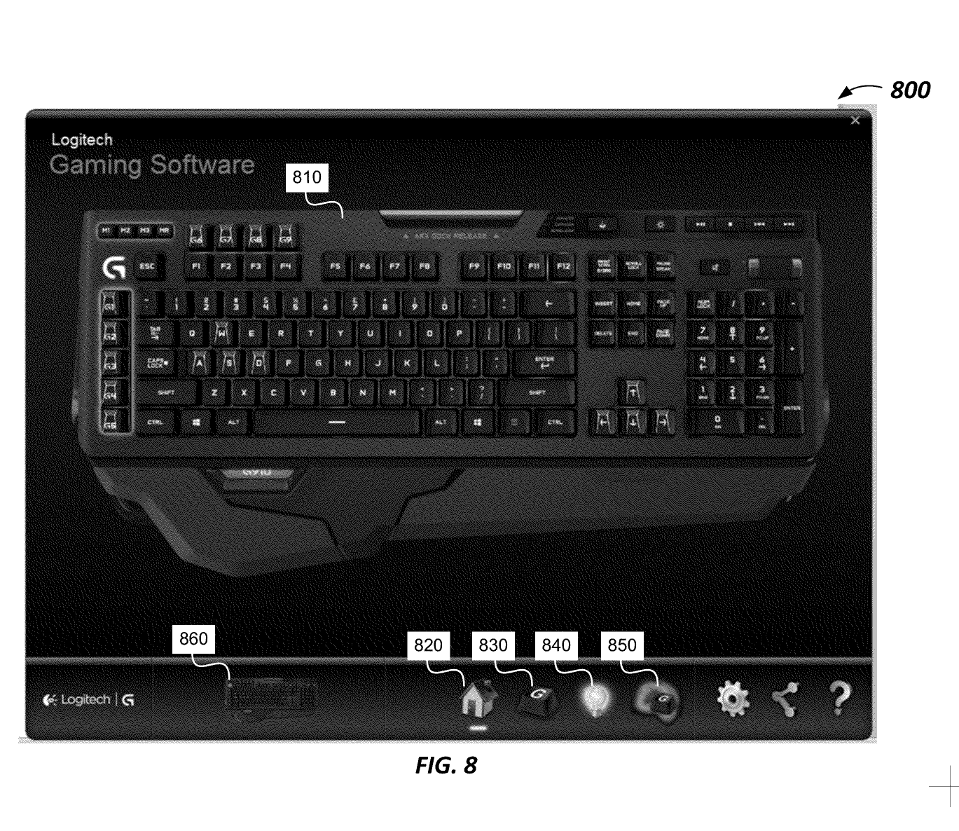

It should be appreciated that the specific steps illustrated in FIG. 8 provide a particular method of generating a use heat map and displaying the use heat map on the keys of a physical input device, according to certain embodiments of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 800.

User Interface for Controlling Peripheral Device

FIG. 8 illustrates a user interface (UI) 800 depicting a virtual keyboard 810, according to certain embodiments of the invention. The UI 800 can be used to control aspects of a physical keyboard (not shown). The keyboard can include keys that are each individually addressable and controllable by a processor to control their key map function, lighting characteristics of an LED associated with each key, and more, all through the UI 800 or similar control software. Although a keyboard 810 is shown, UI 800 can be used to control any type of input device with a plurality of keys including smart phones, key pads, and the like. The current input device 860 is depicted at the bottom left of the display. By selecting the keyboard icon, a selection menu opens and lists each input device that can be controlled by UI 800. Other UI controls include a home screen 820 (as shown in FIG. 8), a key mapping mode 830, a lighting mode 840, and a heat map mode 850. Aspects of the heat map mode 850 are discussed above with respect to FIGS. 1-5.

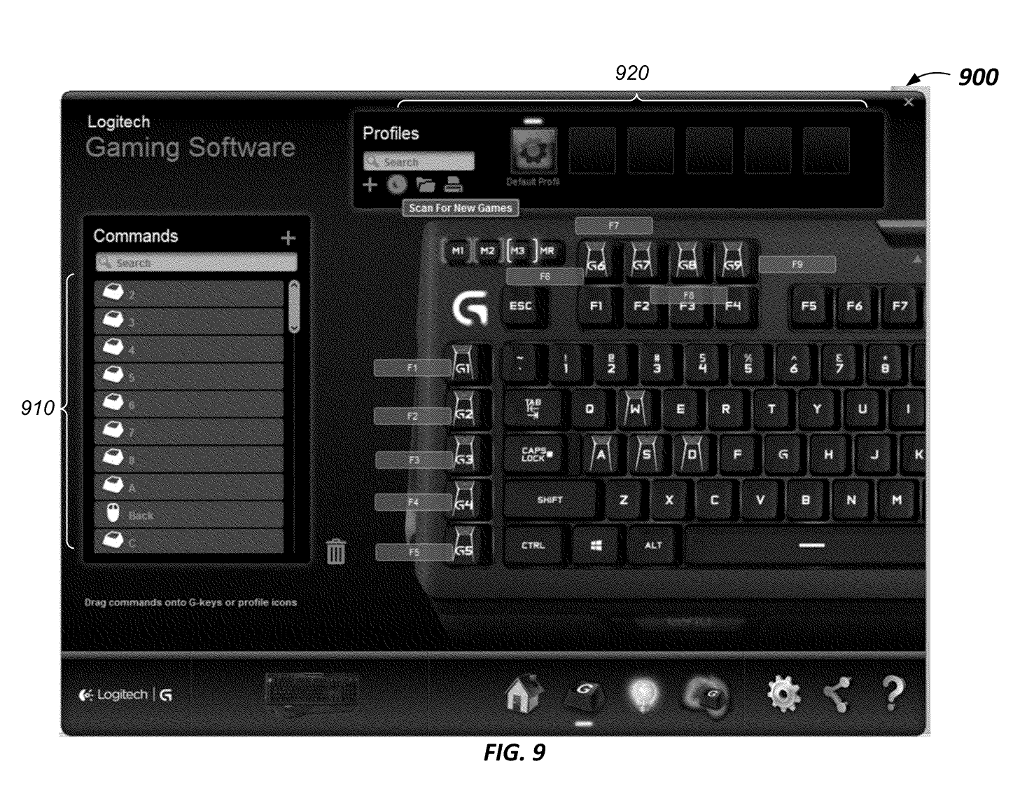

FIG. 9 illustrates user interface 900 in the key mapping mode 830, according to certain embodiments of the invention. UI 800 allows a user to individually assign any hot key, shortcut, function, multi-function, or the like, to any of the keys on the physical keyboard (not shown).

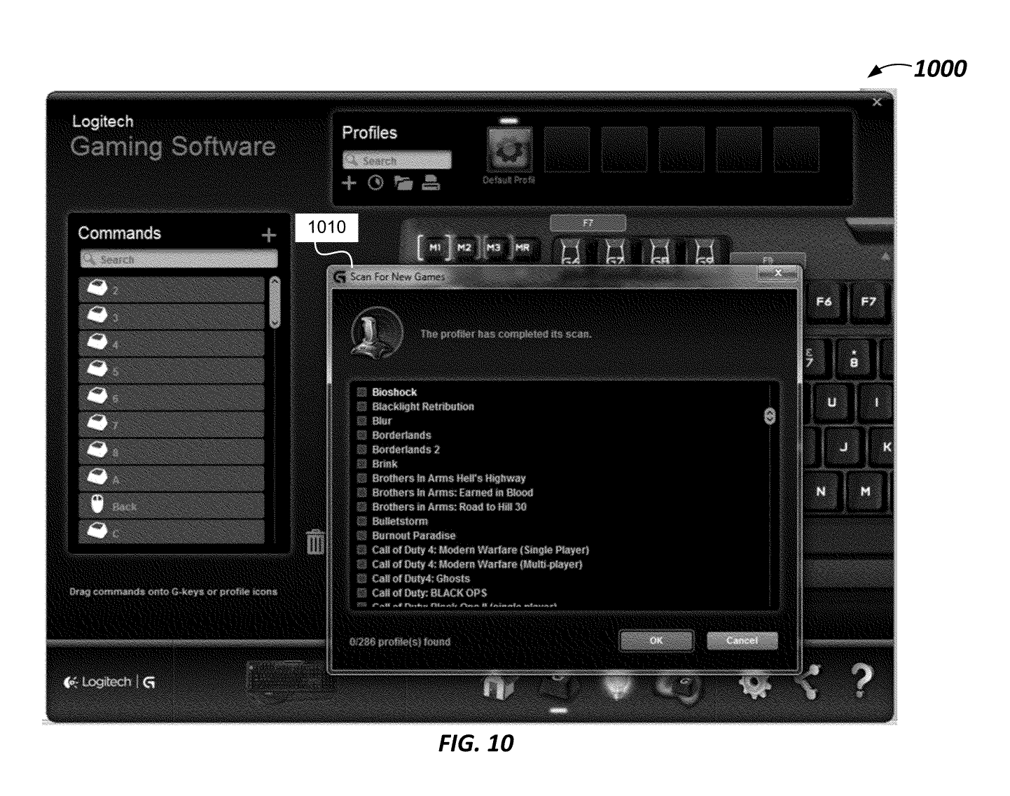

Key command and key function assignments can be set by using the command control interface 910. Profiles interface 920 allows a user to access popular or recommended key mappings (i.e., key bindings) for a number of video games and apply those key mappings to the physical keyboard. This can be advantageous as some optimal key arrangements for massively multi-player online games (MMOs) may have different optimal key arrangements than a typical first person shooter. Instead of having to program each key binding, key profiles for each game can be manually or automatically applied. FIG. 10 illustrates user interface 800 in the key mapping mode 830, according to certain embodiments of the invention. Window 1010 shows an example of a scan to find key maps for newly released games.

Lighting Modes on a Peripheral Device

In certain embodiments of the invention, one or more keys on an input device can be individually addressable and controlled by a processor. The processor can utilize control data including key routing data to individually address each of the keys on the physical keyboard and their associated functions and functions (e.g., LEDs, servos, etc.), and key function data to control the one or more functions. The input device can be a keyboard, mouse, keypad, game controller, or other suitable input device. The processor can be on a host computer, on the input device, on a third device, or a combination thereof. Some exemplary lighting modes are described below, however other lighting modes not explicitly described are anticipated, as would be appreciated by one of ordinary skill in the art with the benefit of this disclosure. Each of the embodiments described herein can be displayed on a screen (e.g., virtual keyboard), on an actual input device (e.g., key LEDs), or both.

Lighting Modes—Custom Control

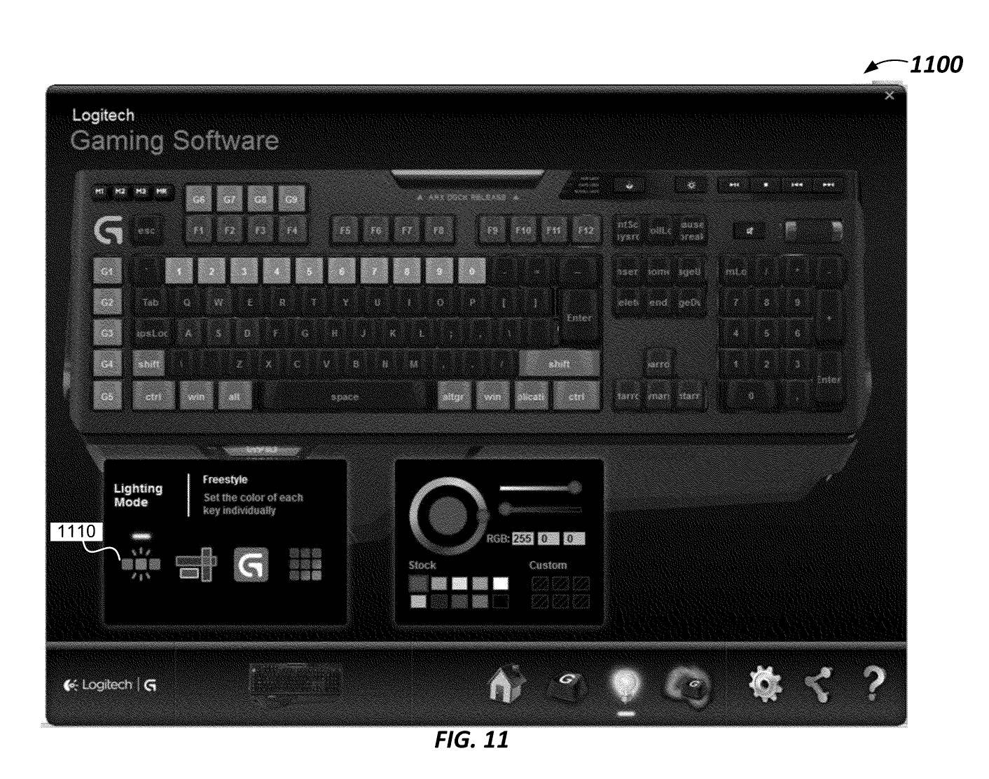

FIG. 11 illustrates an example of a peripheral control software (UI 1100) configured to control lighting parameters for a plurality of keys on a keyboard, according to certain embodiments of the invention. More particularly, FIG. 11 shows the selection of a lighting mode 1110 to individually control the color of each of the one or more keys. In the example shown, the plurality of keys are disposed on a keyboard, and the user set the number keys to yellow, the function keys to red, the arrow keys to blue, and so on. The software interface can include any suitable control mechanism to set the desired color, intensity, brightness, hue, tint, or other suitable lighting parameter, of each individual LED on the corresponding physical keyboard (not shown). Exemplary embodiments may use a color wheel, an RGB field, or other suitable color selection method to set the color for each LED on the physical keyboard. In some embodiments, other physical aspects of each key can be individually controlled, including haptic feedback, key resistance, key functions, and the like.

Lighting Mode—Zones

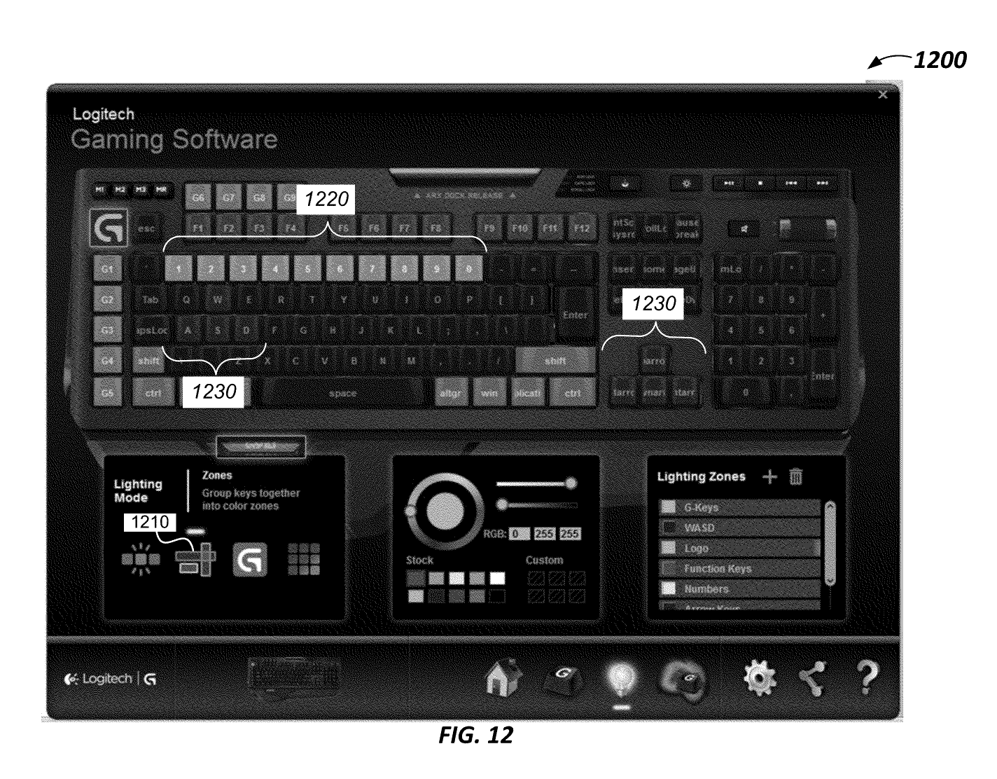

FIG. 12 illustrates an example of peripheral control software (UI 1200) configured to control lighting parameters on a plurality of physical keys, according to certain embodiments of the invention. More particularly, FIG. 12 shows the selection of a zone mode 1210, so that a plurality of keys can be grouped together to form a zone. For instance, the number keys (0-9) are grouped together in a zone 1220 and are assigned a yellow color. The arrow keys and movement keys (W, A, S, D) are grouped together into a second zone 1230 and assigned a blue color. Any set of keys can be grouped together regardless of their relative position and each changes in color, color patterns, etc., can be assigned to each group rather than each individual key.

Lighting Mode—Commands and In-Game Features

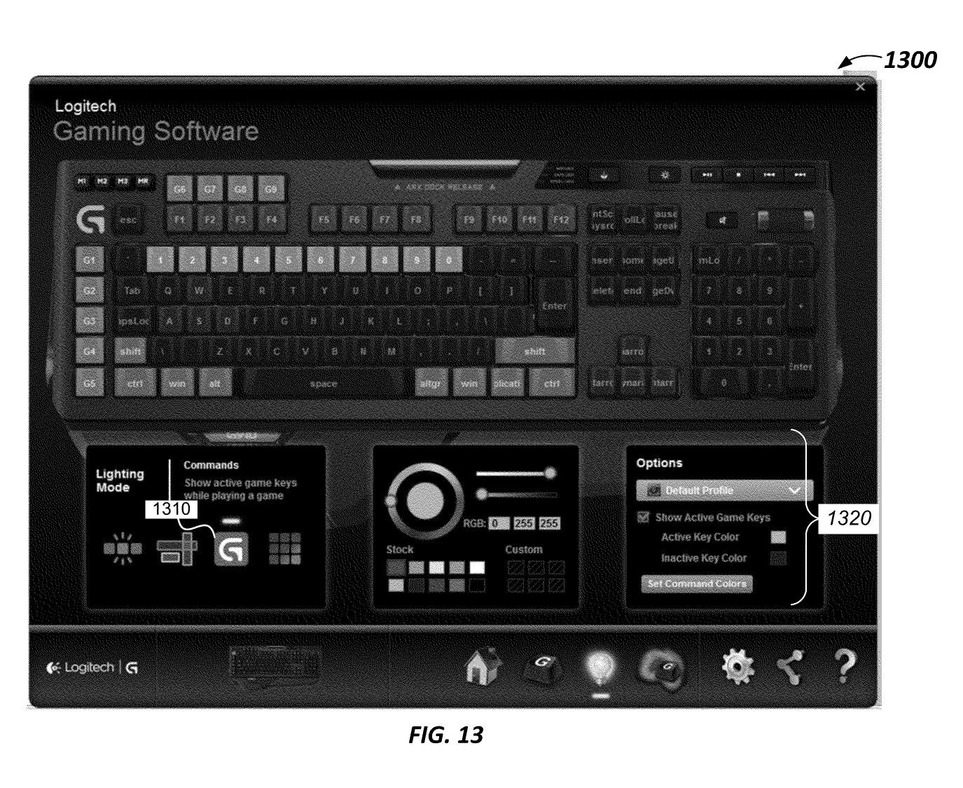

FIG. 13 illustrates an example of peripheral control software (UI 1300) configured to control lighting parameters on a plurality of physical keys, according to certain embodiments of the invention. More specifically, FIG. 13 shows active game keys (mode 1310) while playing a game. Control panel 1320 provides an interface to allow a user to set aspects of both active and inactive keys, including lighting active keys, turning off lighting for inactive keys, and the like. For instance, a user can assign a color to only those keys that are used during a game. There are many, many implementations that utilize software to control application (e.g., game) related lighting parameters on the physical keys. Some non-limiting examples are described below.

In some embodiments, key map configurations can be selected for any suitable application and only the active application keys are illuminated. Key map configurations can be downloaded from any source and/or stored in memory. To illustrate, certain common or popular key map configures for a first-person shooter (FPS) game may be downloaded and displayed on the individual keys of a keyboard or other suitable input device. This can be helpful for newer players who may not remember which keys are active, or may not know a preferred key layout configuration used by experienced or competitive players. Also, by only illuminating active keys, the user can easily see the assigned key layout on the keyboard where typically a newer user would have to constantly refer to map on the display, which may not be possible during play.

In certain embodiments, the peripheral control software can detect an application currently being used and set an appropriate key grouping or key layout. For example, the control software can detect that the FPS is currently executing and provide a predetermined key layout. When a second application is executed, the control software can detect its launch and provide an alternative key layout better suitable to that particular application.

In some embodiments, the software may further determine a user's proficiency by analyzing certain key press metrics, as would be appreciated by one of ordinary skill in the art, and change a key grouping or key layout that is better suited for a particular skill level.

In further embodiments, unused keys can be enabled or disabled according to preference. For instance, the Windows key (or equivalent) typically causes the active window to close or it may open a Windows menu. This can be very disruptive to a user in a competitive game. Thus, the Windows key can be individually addressed and programmed to be disabled to prevent this from happening during a gaming session.

In another example, accidentally pressing the ˜key can cause a chat window to open. This can be very disruptive to a user, especially when it is inadvertently pressed. Thus, the ˜key can be individually programmed to be disabled during the operation of a particular application (e.g., video game). Alternatively, a user may opt to frequently use the chat mode during game play. In the case where unused keys are disabled for a particular game, the control software can temporarily re-enable the disabled keys when the chat mode is entered. In addition, the control software can change the color of the keys on the keyboard to indicate this condition.

In certain implementations, the control software can cause a chat mode color change to also occur independent of disabling the keys. For example, it may be helpful to a gamer to get a visual indication that she has entered the chat mode so when she attempts to move in the game and nothing happens, she can glance down and see the keyboard LEDs are all white and know that she is in the chat mode. In another embodiment, entering chat mode (or other mode) causes the keyboard LED intensity to change. In the example above, if the keyboard LEDs change to white and get very bright, then the gamer would be able to determine that she entered chat mode without looking down (and potentially interrupt game play) by using only her peripheral vision to detect the change in brightness. This concept of bright colors, intensity, etc., can also be applied to certain game play elements.

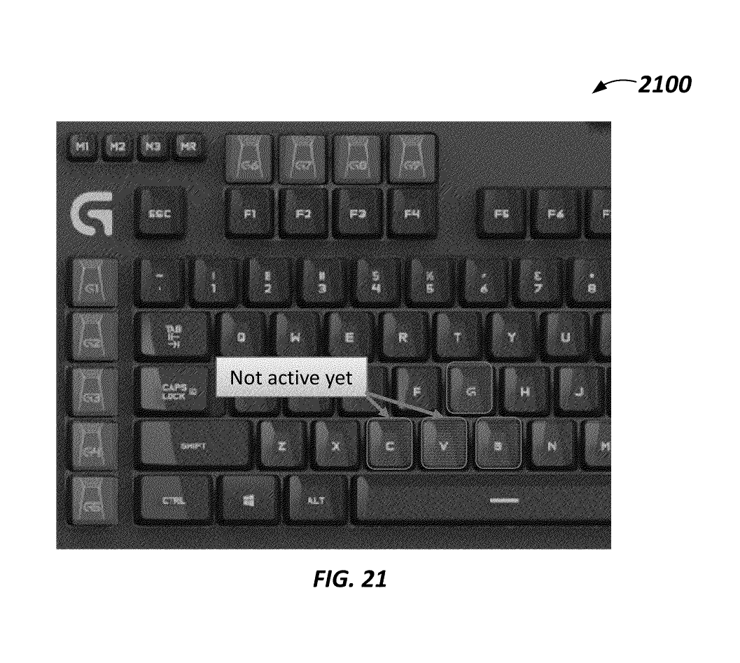

As previously discussed, certain in-game functions may take time to “recharge.” For instance, a spell may take some time before a user can use it again, or a grenade may be unavailable until another is picked up. In one aspect, once these functions become enabled, it may be advantageous to really get the gamer's attention by causing the color of the corresponding key and LED to flash, have a very high brightness, have a bright color (e.g., white), or a combination thereof. They can remain in this condition, or fade/change to whatever setting per user preference. Alternatively, keys can slowly fade in as a function becomes available. FIG. 21, for example, illustrates usable keys in green and unusable keys (not active yet) in orange, according to certain embodiments of the invention. As the function associated with the orange keys become available, the color can switch or slowly shift from orange to green. Aspects of brightness and contrast can be implemented to supplement the color shifting and switching characteristics. Further still, certain keys may remain off and only light up when those options are available. For instance, when a particular game mode is selected (e.g., a “build” mode in a real-time strategy game), only the keys assigned to functions available in that mode will light up. When the mode is exited, only keys that correspond to functions that can be used in the new mode of operation are illuminated. In some embodiments, the control software may also disable keys not available in a particular mode or assign some haptic (e.g., vibration) or visual feedback (e.g., flashing LED on the key, indicator on the screen, etc.) indicating to a user that the particular key is not associated with a function in that mode of operation.

In certain embodiments, the control software can track a player's actions during a game by tracking key presses during the course of a game, as is typically done with heat mapping. Furthermore, while the control software may not be able to determine what is happening on the screen directly, the software can detect what is being sent to the keyboard. For example, if a FPS game sends a signal to the keyboard that grenades are now available, the control software can be configured to change the color (intensity, flash pattern, etc.) key assigned to that function.

In some embodiments, the control software can also independently track how long a certain in-game function is executed without detecting what is happening on the screen directly. For instance, after a game the control software could present data to a user indicating that she waits 5.4 seconds between having a grenade available and when she uses it. Information such as this could be useful metrics in helping gamers adjust strategy and analyze their game play characteristics. Other in-game behaviors can be gleaned based on the timing and order of key presses over a period of time, as would be appreciated by one of ordinary skill in the art with the benefit of this disclosure. For example, are grenades thrown while running or crouching, are they thrown after sustained bursts of weapon fire? The control software can answer these inquiries and more, based on an accumulation of key presses over a period of time, which can be saved in a session as described above with respect to FIG. 2. In another example, the control software may be able to determine when a game is in game-play mode of a non-playable cut-scene mode based on whether buttons are being pressed (e.g., during chat mode, gaming mode, etc.). Other applications of individual LED control on an input device are possible and would be appreciated by one of ordinary skill in the art.

Lighting Mode—Lighting Effects

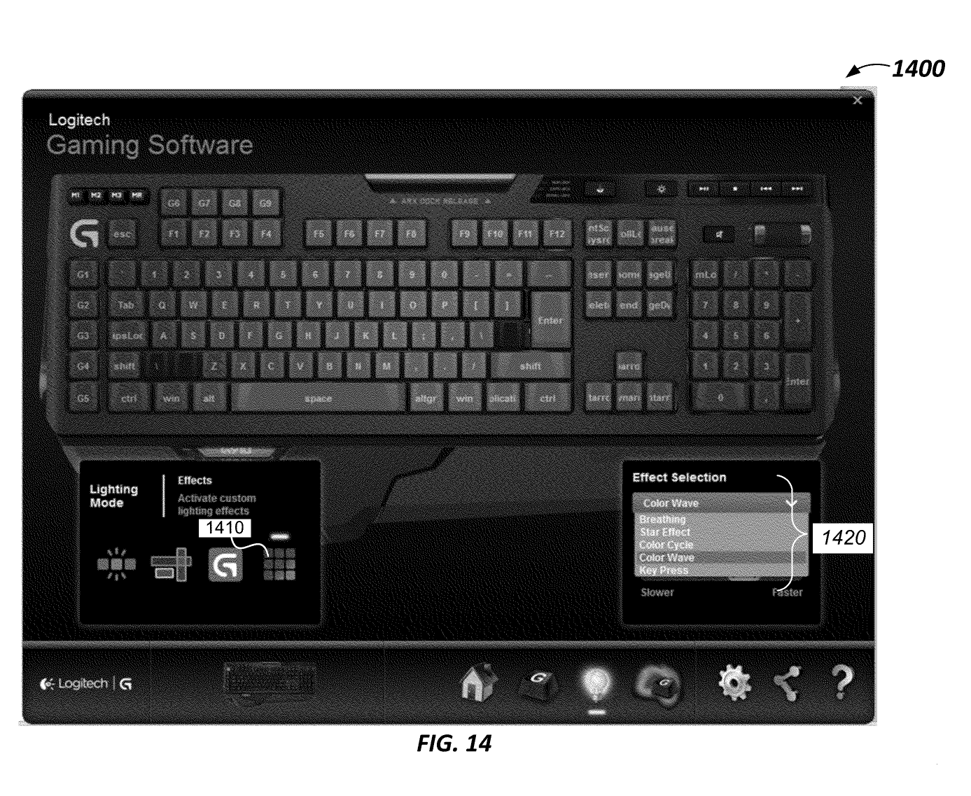

FIG. 14 illustrates an example of peripheral control software (UI 1400) configured to control lighting parameters on a plurality of physical keys, according to certain embodiments of the invention. More specifically, FIG. 14 shows the selection of lighting mode 1410 to select different lighting patterns that can be applied to the plurality of physical keys. Some exemplary lighting patterns include a breathing pattern, star effect, color cycle, color wave, key press, lightning pattern, space travel pattern, water pattern, centipede pattern, or any other preferred lighting pattern, which may be available via default settings or user definable parameters. In some embodiments, a user can select the desired lighting effect via effect control menu 1420.

Breathing patterns can be programmed to include fading in and out of a particular color at a particular rate to emulate the breathing pattern of a human. The star effect can be programmed to randomly select and illuminate one or more keys for a period of time. The selected key(s) typically have contrasting colors that fade in and out to simulate twinkling starts in the night sky. Color cycles can be programmed to cause the LEDs to cycle through a number of colors. The LEDs can cycle through any number of colors at any particular rate or pattern according to preference. Key press patterns may be similar to the heat map patterns discussed above. For example, keys can change colors as they are pressed. Keys may continue to change color as they are repeatedly pressed and colors may fade or change to other colors based on aspects of key press timing. Lightning patterns can cause keys to light up in patterns that simulate lightning strike patterns, and space travel patterns can cause LEDs to light up so it appears that stars are flying towards the user. In some embodiments, water patterns can change color and brightness to simulate waves in water. Furthermore, key presses can cause LEDs to change color and/or brightness to simulate splashes or disruptions in the wave pattern. Finally, centipede patterns can cause LEDs to light up to simulate movement of a centipede across the plurality of keys, similar to a classic arcade game. Any number of lighting effects are possible and fully user customizable.

Miscellaneous Control Features

In certain embodiments, aspects of virtual coaching can be implemented, as described above. In addition to time-based analytics, which can be used to passively coach a user (i.e., after a session is already complete), certain in-game coaching features may be used. For instance, certain keys can be lighted to indicate a useful option or recommended move. Haptic feedback can be used in key situations to alert a gamer to a certain event. To illustrate, a new player may not be aware of a location of an enemy. The control software can cause certain keys to illuminate brightly to indicate a relative direction of the enemy for advanced notice. Some keys may experience haptic feedback to indicate a recommended move. For instance, the backwards movement key may light up or vibrate (i.e., haptic feedback) to quickly suggest the optimal move to minimize or prevent player damage. Or, certain keys can light up to suggest that the gamer use a particular weapon for a particular enemy. The many, many possible implementations would be appreciated by one of ordinary skill in the art with the benefit of this disclosure.

Supplementary Screen Control

In some embodiments, control parameters for a peripheral device can be controlled on a supplementary screen. This may be advantageous when parametric controls need to be adjusted in real-time. For example, a first display may depict a FPS-styled application and a second display may depict a keyboard (e.g., FIG. 1-3). In conventional systems, if a user wanted to a key assignment, key layout, or other parameter, she would have to close the FPS game, change the parameter(s), and reload the game. In some embodiments, changes can be made to any parameter of the peripheral device in real-time on the second display, which will in-turn affect the performance of the parameter in-game in real-time, without having to exit the application.

In certain embodiments, a second screen gaming experience can supplement or replace contemporary LCD (liquid crystal display) equipped keyboards by moving the displayed content to a mobile device (e.g., tablet computer, smart phone, etc.). As such, any of the technical capabilities of the second screen can be utilized for an improved user input (UI) experience. For instance, a second screen can be touch sensitive, wireless (e.g., Bluetooth communication), and can utilize any on-board function, sensor, or resource (e.g., in-game text messaging) on the secondary device. Any suitable mobile platform can be supported (e.g., iOS, Android, etc.). Applets can be built-in, provided by game developers, or developed by third parties.

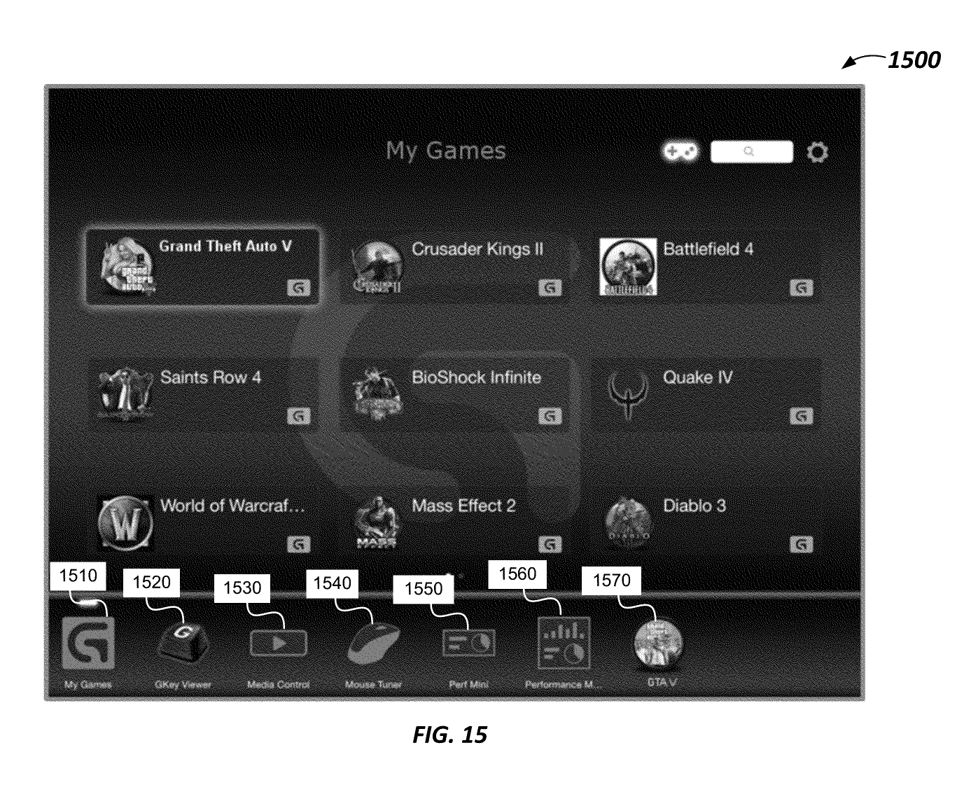

FIG. 15 illustrates an example of a user interface 1500 to control aspects of the operation of a supplementary display, according to certain embodiments of the invention. A UI 1500 includes a number of selectable applets including a listing of current games 1510 (selected in FIG. 15), a key map controller 1520, a media controller 1530, an input device tuner 1540, a mini performance dashboard 1550, a performance dashboard 1560, and a current selected game icon 1570. UI 1500 can include some or all of the applets, or any other suitable applet configured to run on a secondary device.

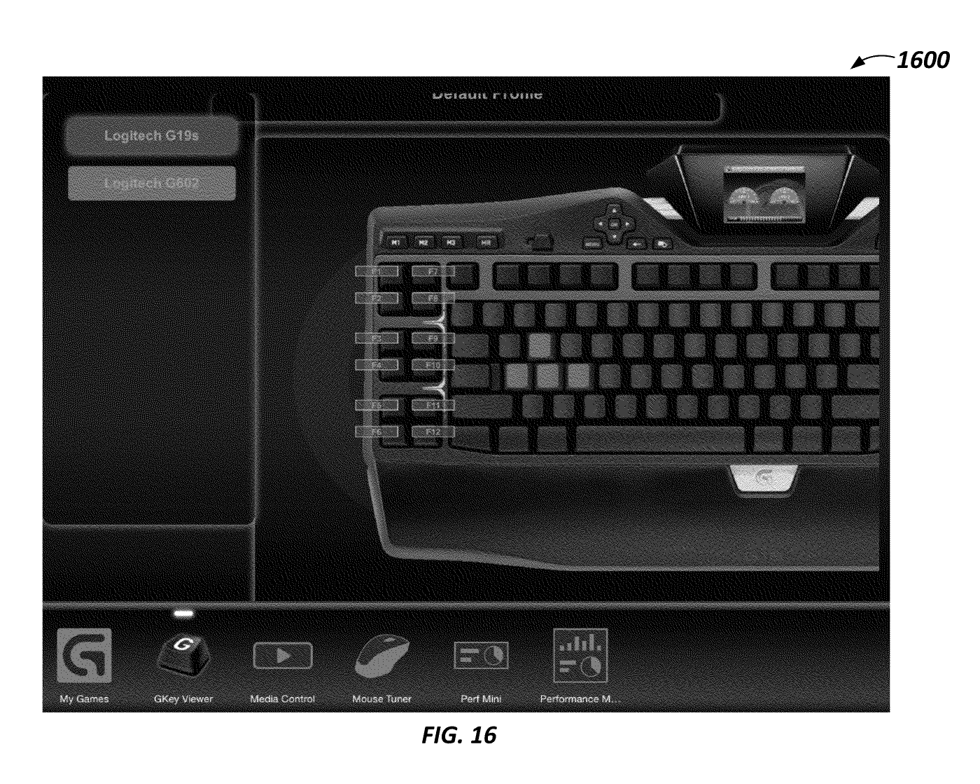

FIG. 16 illustrates an example of a UI 1600 for controlling key mapping aspects of the operation of a supplementary display, according to certain embodiments of the invention. More specifically, FIG. 16 illustrates a key map controller 1520. Key map control for the UI 1600 may include similar features as those discussed with respect to FIGS. 9-10. In some embodiments, the key map controller 1520 can show keyboard assignments at a glance, switch views between multiple gaming input devices, show a current profile, mode, battery status, as well as zooming and panning options. Other functions can be implemented, as would be appreciated by one of ordinary skill in the art with the benefit of this disclosure.

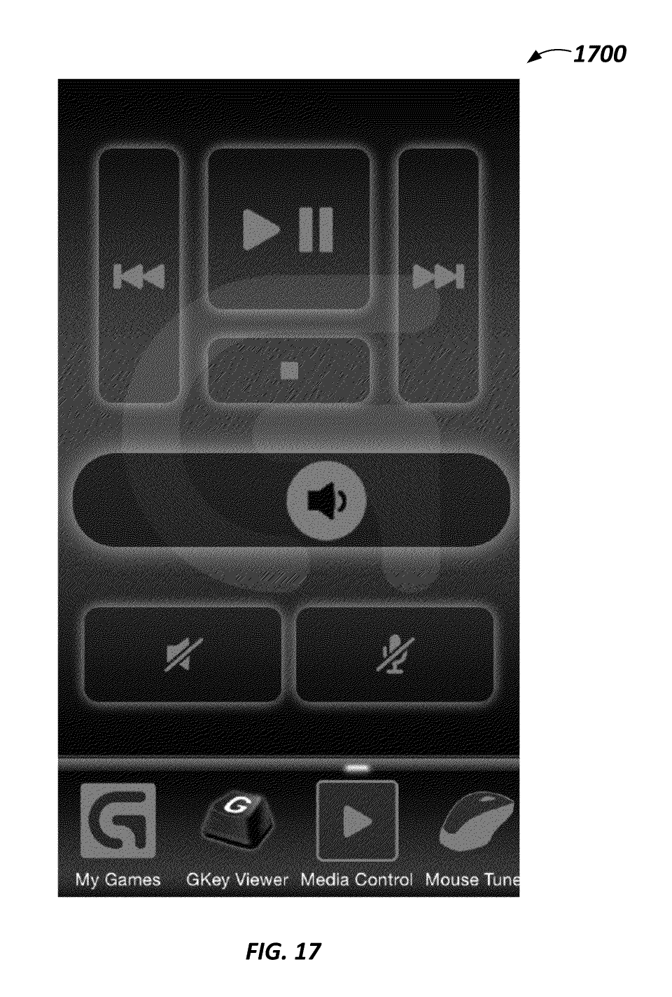

FIG. 17 illustrates an example of a UI 1700 for controlling media aspects from a supplementary display, according to certain embodiments of the invention. More specifically, FIG. 17 illustrates a media control interface. In some implementations, UI 1700 can control media play on a computing device, control standard tape controls (e.g., play, pause, mute, volume control, skip, forward, backwards, etc.), and the like.

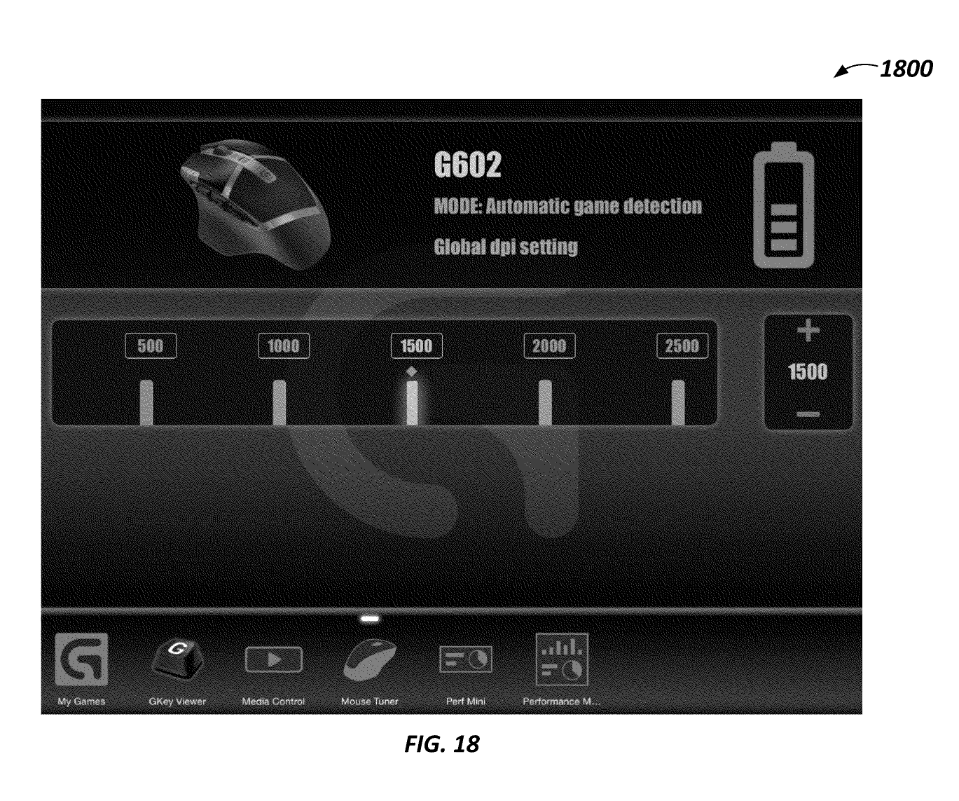

FIG. 18 illustrates an example of a UI 1800 for controlling aspects of the operation of an input device from a supplementary display, according to certain embodiments of the invention. More specifically, FIG. 18 illustrates a mouse tuning interface. In certain embodiments, the input device tuner can depict mouse DPI or other information including a current device mode (e.g, auto game detection), current game profile, axis settings, scrollable views, DPI controls, multiple input device support (e.g., 2 or more mice), current mode of operation, battery status, and the like.

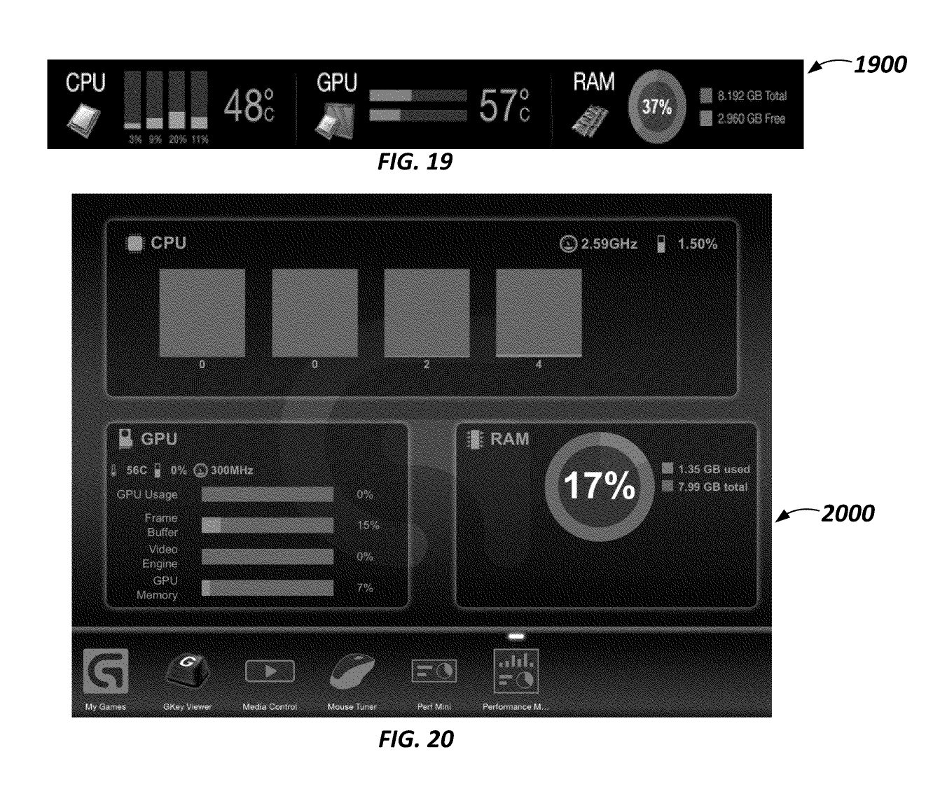

FIGS. 19 and 20 illustrate examples of a UI 1900, 2000 for displaying performance characteristics of a system from a supplementary display, according to certain embodiments of the invention. More specifically, FIG. 19 illustrates a compact or mini performance bar and FIG. 20 illustrates a full-size display. In some embodiments, a performance monitor can show CPU load (multiple cores), clock speed, GPU load, temperature, clock speed, fan speed, frame buffers, video engine, memory usage, or any desired performance metric.

Sample Embodiments of System Architectures

FIG. 22 is a simplified block diagram illustrating a system 2200 for operating a secondary interactive display and controlling aspects of each individual key in a physical keyboard 2210, according to certain embodiments of the invention. System 2200 includes a first computing device 2250 and a secondary computing device 2270. First computing device 2250 includes application software (e.g., game software 2252), control software 2256 (e.g., UI 800), and software development kit 2254. The SDK 2254 is positioned between and is in communication with application software 2252 and control software 2256. In some cases, first computing device 2250 can be a personal computer, game system, or the like. A remote access controller 2275 is installed on secondary computing device 2270. Secondary computing device 2270 can be any suitable computing device including a mobile phone, tablet computer, or other mobile computing device, however non-mobile computing devices are anticipated. Remote access controller applet 2275 is in wireless communication with control software 2256 of first computing device 2250.

Remote access controller 2275 can be a self-contained element of the control software suite (combination of software 2275 and 2256) that can provide the visual rendering and display of external application data. The data is provided to remote access controller 2275 by control software 2256 via the wireless connection 2260. Once a connection is established between the remote access controller 2275 and control software 2256, data is passed between the two applications to communicate status, update display data, provide state information, and the like, as further discussed with respect to FIGS. 15-20.

In layman's terms, an applet can be a small (i.e., relatively low memory requirement) application that runs on a computing device (e.g., personal computer) and can provide information in the form of text and layout to control software 2256. In some embodiments, an applet can be an implementation of control software SDK 2254 in a game, directly in control software 2256, or in a stand-alone program to deliver the contents to the secondary device (e.g., smart device) over wifi path 2260. An applet can be an interactive combination of HTML, CSS, Javascript, images, or other data, as would be appreciated by one of ordinary skill in the art. Files can be sent from game 2252 to control software 2256 using SDK 2254, as would be appreciated by one of ordinary skill in the art. Control software 2256 can transfer these files to remote access controller 2275. The SDK 2254 can allow game to update the applet during game play. For example, property updates can be sent through SDK 2254 to control software 2256 and thereafter to remote access controller 2275. The game 2252 can interpret the commands and update the content of the applet.

FIG. 22 further includes a keyboard 2210, a processor 2240 associated with the first computing device 2250, and a multiplexor 2290. Processor 2240 can operate aspects of the first computing device 2240. In some embodiments, processor 2240 receives control data (having key routing data and key function data) from the control software 2256 and controls aspects of keyboard 2210. System 2200 can be used to implement any of the embodiments described herein as well as embodiments not specifically described but anticipated by this disclosure.

Processor 2240 can be part of the first computing device 2250, part of keyboard 2210, or processors on each can work in conjunction with one another. Keyboard 2210 includes a number of keys 2220. Each key is individually addressable by the processor via the multiplexor 2290 and each individual connection 2225. The wiring schematic shown in FIG. 22 is illustrative of one way of individually addressing and controlling one or more keys on an input device. Other methods are anticipated and would be appreciated by one of ordinary skill in the art with the benefit of this disclosure.

Each key 2220 can include an LED 2230. LED 2230 can be disposed within key 2220, adjacent to key 2220, or in any other suitable configuration provided that LED 2230 corresponds to the particular key. In some embodiments, keys 2220 can include a servo or motor to provide a haptic feedback or vibration for each individual key. Some or all of the keys 2220 can include LEDs, motors, or other feature, with each feature being individually controlled a processor.

FIG. 23 is a simplified schematic diagram of a computer system 2300, according to certain embodiments of the present invention. The computer system 2300 includes a computer 2310, a monitor 2320, a keyboard 2330, and an input device 2340. In one embodiment, the keyboard 2330 can be any suitable input device with one or more keys. The physical embodiments of the various keyboards with individually addressable keys, and the like, described herein (e.g., FIGS. 1-22 and 24) can be implemented by the keyboard 2330 and the computer 2310.

Computer 2310 may include a machine readable medium (not shown) that is configured to store computer code, such as mouse driver software, keyboard driver software, and the like, where the computer code is executable by a processor (not shown) of the computer 2310 to affect control of the computer 2310 by input device 2340 and keyboard 2330.

The keyboard 2330 can be configured such that one or more keys can be individually addressable and controlled. Each addressable and controllable key can include a corresponding LED, motor, or the like. For instance, keyboard 2330 can have features similar to the keyboard 2210 of FIG. 22 and can be used as described in the various embodiments throughout this disclosure (e.g., see FIGS. 1-22 and 24).

Input device 2340 can include a number of buttons that are individually addressable and controllable as well, similar to keyboard 2230 of FIG. 22. The adaptation of the inventive concepts described herein to an input device such as a mouse with a number of addressable and controllable buttons would be appreciated by one of ordinary skill in the art with the benefit of this disclosure.

FIG. 24 illustrates a simplified representation of a computer system 2400 for generating a use heat map for a peripheral device, according to certain embodiments of the invention. The software (e.g., heat mapping software, peripheral controller, secondary display controllers, etc.), systems, and methods described herein (e.g., FIGS. 1-23) can be implemented within a computer system such as computer system 2400 shown here. Computer system 2400 can be implemented as any type of computing devices, including, e.g., server(s), a desktop or laptop computer, a tablet computer, a smart phone, a personal digital assistant (PDA), or any other type of computing device, not limited to any particular form factor. Computer system 2400 can include processing unit(s) 2430, a storage subsystem 2410, input devices 2450 (e.g., keyboards, mice, touchscreens, etc.), output devices 2460 (e.g., displays, speakers, tactile output devices, etc.), a network interface 2470 (e.g., RF, 4G, EDGE, WiFi, GPS, Ethernet, etc.), and a bus 2405 to communicatively couple the various elements of system 2400 to one another. In some embodiments, the input device(s) 2450 can include keyboards or mice having individually addressable and controllable keys, as described above with respect to FIGS. 7-15.

Processing unit(s) 2430 can include a single processor, multi-core processor, or multiple processors and may execute instructions in hardware, firmware, or software, such as instructions stored in storage subsystem 2410. The storage subsystem 2410 can include various memory units such as a system memory, a read only memory (ROM), and permanent storage device(s) (e.g., magnetic, solid state, or optical media, flash memory, etc.). The ROM can store static data and instructions required by processing unit(s) 2430 and other modules of the system 2400. The system memory can store some or all of the instructions and data that the processor needs at runtime.

In some embodiments, the storage subsystem 2410 can store one or more of data or software programs to be executed or controlled by processing unit(s) 2430, such as key control data 2412, time-based analytics data 2414, or key layout database 2416, as further described above with respect to FIGS. 1-5. As mentioned, “software” can refer to sequences of instructions that, when executed by processing unit(s) 2430, cause computer system 2400 to perform certain operations of the software programs. The instructions can be stored as firmware residing in read only memory and/or applications stored in media storage that can be read into memory for processing by processing unit(s) 2430. Software can be implemented as a single program or a collection of separate programs and can be stored in non-volatile storage and copied in whole or in part to volatile working memory during program execution. From storage subsystem 2410, processing unit(s) 2430 can retrieve program instructions to execute in order to execute various operations (e.g., interpolations) described herein. In certain embodiments, system 2400 can perform the operations described above with respect to FIGS. 1-21.

It will be appreciated that the computer system 2400 is illustrative and that variations and modifications are possible. Computer system 2400 can have other capabilities not specifically described here in detail. Further, while computer system 2400 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Aspects of system 2400 may be implemented in many different configurations. In some embodiments, system 2400 may be configured as a distributed system where one or more components of system 2400 are distributed over one or more networks in the cloud.

While the invention has been described with respect to specific embodiments, one of ordinary skill in the art will recognize that numerous modifications are possible. Thus, although the invention has been described with respect to specific embodiments, it will be appreciated that the invention is intended to cover all modifications and equivalents within the scope of the following claims.

It should be understood that terms such as “input device,” “peripheral device,” and the like, are used interchangeably throughout this document and are not limiting. Also, the term “control software” can refer to software that runs the various UI's (e.g., UI 800) and exemplary embodiments described herein.

The above disclosure provides examples and aspects relating to various embodiments within the scope of claims, appended hereto or later added in accordance with applicable law. However, these examples are not limiting as to how any disclosed aspect may be implemented.

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

What is claimed is:

1. A computer implemented method comprising:
receiving input from an input device having a plurality of keys, the input corresponding to individual key presses of the plurality of keys;
tracking the individual key presses over a period of time;
determining time-based analytics for each of the individual keys, wherein the time-based analytics includes a key press frequency over the period of time;
providing a graphical representation of the plurality of keys; and
modifying the graphical representation of each of the plurality of keys based on the time-based analytics.

2. The computer implemented method of claim 1 wherein the time-based analytics further includes a duration of each key press over the period of time.

3. The computer implemented method of claim 1 wherein the graphical representation of the plurality of keys is a heat map.

4. The computer implemented method of claim 1 further comprising:
storing the individual key presses over the period of time as a session.

5. The computer implemented method of claim 1 wherein the session is one of a per-game session, per-application session, or per-period session.

6. The computer implemented method of claim 1 further comprising:
determining a weighted average of the keys with the highest key press frequency; and
generating a graphical representation of the weighted average.

7. The computer-implemented method of claim 1 further comprising:
analyzing the time-based analytics for each of the individual keys over the period of time;
identifying ergonomic inefficiencies based on the time-based analytics; and
determining an ergonomically-improved key mapping configuration based on the time-based analytics.

8. A computer-implemented system, comprising:
one or more processors;
one or more non-transitory computer-readable storage mediums containing instructions configured to cause the one or more processors to perform operations including:
generating control data to control a peripheral device, the control data including:
key routing data to individually address one or more keys on the peripheral device; and
key function data to control one or more functions associated with the one or more keys of the peripheral device; and
controlling the individually addressed one or more keys on the peripheral device based on the key function data.

9. The computer-implemented system of claim 8 wherein a light is disposed within or adjacent to each of the one or more keys, and wherein the key function data controls one or more of a color, brightness, and lighting pattern for the light of the one or more keys.

10. The computer-implemented system of claim 9 wherein the light is a light emitting diode (LED).

11. The computer-implemented system of claim 9 wherein the one or more non-transitory computer-readable storage mediums further contain instructions configured to cause the one or more processors to perform operations including:
receiving input data from the peripheral device corresponding to key presses of the one or more keys; and
determining time-based analytics for each of the individual keys, wherein the time-based analytics includes a key press frequency over a period of time.

12. The computer-implemented system of claim 11 wherein the key function data causes the light for each of the one or more keys to have a particular color, brightness, or lighting pattern based on the time-based analytics for that particular key.

13. An input device comprising:
a plurality of keys;
a plurality of LEDs, wherein each LED is associated with one of the plurality of keys; and
a processor to:
individually address each LED; and
individually control a function of each LED including a color, brightness, or lighting pattern,
wherein the processor determines time-based analytics for each of the plurality of keys,
wherein time-based analytics includes a key press frequency over a period of time, and
wherein the processor controls the function of each LED based on the time-based analytics for that particular key.

14. The input device of claim 13 wherein the processor is operable to receive control data from a host computing device, the control data including:
key routing data to individually address one or more of the plurality of LEDs on the peripheral device; and
key function data to control one or more functions associated with the one or more keys of the peripheral device,
wherein the processor further controls the function of each LED based on the key function data from the host computing device.

15. The input device of claim 14 wherein the processor is configured to determine a key mapping configuration based on the time-based analytics.

16. A keyboard comprising:
a plurality of keys;
a plurality of LEDs, wherein each LED is associated with one of the plurality of keys; and
a processor configured to:
individually address each LED; and
individually control a function of each LED including a color, brightness, or lighting pattern.

17. The keyboard of claim 16 wherein the processor is disposed in the keyboard.

18. The keyboard of claim 16 wherein the processor is disposed in and controlled by a host device separate from the keyboard.

19. The keyboard of claim 16 wherein the processor is further configured to individually address each key.

20. The keyboard of claim 16 wherein the processor is configured to receive and process control data from a host device,
the control data including:
key routing data to individually address one or more of the plurality of keys on the keyboard; and
key function data to control one or more functions associated with the one or more keys of the plurality of keys on the keyboard.
